(19) United States
(12) Patent Application Publication
(10) Pub. No.: US 2012/0249853 A1
(43) Pub. Date: Oct. 4, 2012

(54) DIGITAL CAMERA FOR REVIEWING RELATED IMAGES

(76) Inventors: Marc Krolczyk, Spencerport, NY (US); Timothy L. Nichols, Spencerport, NY (US); Marc Nicolas Gudell, Penfield, NY (US)

(21) Appl. No.: 13/072,815

(22) Filed: Mar. 28, 2011

(51) Int. Cl. H04N 5/222

(52) U.S. Cl. 348/333.01; 348/E05.022

(57) ABSTRACT

A digital camera system for capturing and reviewing a group of related digital still images, comprising: an image sensor for capturing a digital image; a user interface including one or more user interface elements; a storage memory; and a program memory storing instructions configured to cause a data processing system to implement a method for capturing and reviewing a group of related digital still images. The instructions include: capturing and storing a group of related digital still images of the scene at a sequence of image capture times; providing a user interface for enabling a user interface to select a stored group of related digital still images for review; providing a user interface for enabling the user to delete a subset of the digital still images.

### CROSS-REFERENCE TO RELATED APPLICATIONS

Reference is made to commonly assigned, co-pending U.S. patent application Ser. No. ______ (docket 96751), entitled: “Display device for displaying related digital images,” by Krolczyk et al., which is incorporated herein by reference.

### FIELD OF THE INVENTION

This invention pertains to the field of digital imaging and more particularly to a digital camera system for reviewing a group of related digital still images.

### BACKGROUND OF THE INVENTION

In recent years, digital camera systems have become ubiquitous. Because digital camera systems provide a convenient and low-cost means for capturing many images, many users have amassed large collections of digital images. Digital image collections may include digital videos and other types of digital media assets, as well as conventional digital still images. A problem associated with these collections of digital media assets is that they are often so large that it is not possible to easily find a particular image of interest. As a result, many users rarely, if ever, access or use the vast numbers of digital images in their collection.

One way to address this problem is to provide convenient mechanisms for organizing a collection of images into groups of digital images related to particular events. While a lot of research has been done in the area of image organization, it remains largely a manual labor-intensive process at this time. As a result, many people just give up. One factor which only exacerbates this problem is that users often capture groups of related digital images of a particular scene (e.g., using a burst capture mode). Each digital image in such groups of related digital images is treated as an individual digital media asset, which greatly multiplies the complexity of the image organization task.

There remains a need for a method to conveniently organize, edit and utilize groups of related digital media assets in a collection of digital media assets.

### SUMMARY OF THE INVENTION

The present invention represents a digital camera system for capturing and reviewing a group of related digital still images, comprising:

an image sensor for capturing a digital image;

an optical system for forming an image of a scene onto the image sensor;

a softcopy display;

a user interface including one or more user interface elements, wherein one of the user interface elements is an image capture control;

a data processing system;

a storage memory for storing captured images; and

a program memory communicatively connected to the data processing system and storing instructions configured to cause the data processing system to implement a method for capturing and reviewing a group of related digital still images, wherein the instructions include:
sensing an activation of the image capture control at a nominal image capture time;
capturing a group of related digital still images of the scene at a sequence of image capture times including a primary digital still image captured substantially at the nominal image capture time;
storing the group of related digital still images in the storage memory, together with information indicating that the digital still images are related;
providing one or more user interface elements for enabling a user to select a stored group of related digital still images for review on the softcopy display;
providing one or more user interface elements for enabling the user to designate a subset of the digital still images in a selected group of related digital still images for deletion; and
providing one or more user interface elements to initiate the deletion of a designated subset of digital still images from the selected group of related digital still images.

This invention has the advantage that users can conveniently capture and review groups of related digital still images. A mechanism is provided so that each group of related digital still images can be treated as a single digital media asset by the digital camera, and by other digital imaging system components.

It has the further advantage that users can conveniently delete any digital images in the group of related digital still images that they do not want to keep.

It has the additional advantage that users can conveniently select a particular digital image in the group of related digital still images to be the primary digital still image.

### BRIEF DESCRIPTION OF THE DRAWINGS

FIG. 1 is a high-level diagram showing the components of a digital camera system;

FIG. 2 is a flow diagram depicting typical image processing operations used to process digital images in a digital camera;

FIG. 3 is a flow chart of a method for reviewing a group of related digital still images;

FIG. 4 illustrates a group of related digital images;

FIG. 5 illustrates a user interface for an image review process;

FIG. 6 illustrates a user interface for enabling a user to edit a group of related digital still images;

FIG. 7 illustrates a user interface for enabling a user to edit various image attributes for a selected digital still image;

FIG. 8 illustrates an example of timeline for capturing a group or related digital still images;

FIG. 9 shows an example of a file folder structure that can be used to store a collection of digital media assets that includes groups of related digital still images;

FIG. 10 shows an example of a composite image created for a group of related digital still images; and

FIG. 11 illustrates the storage of a group of related digital still images in a single EXIF file.

It is to be understood that the attached drawings are for purposes of illustrating the concepts of the invention and may not be to scale.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of a digital camera will be familiar to one skilled in the art. It will be obvious that there are many variations of this embodiment that are possible and are selected to reduce the cost, add features or improve the performance of the camera.

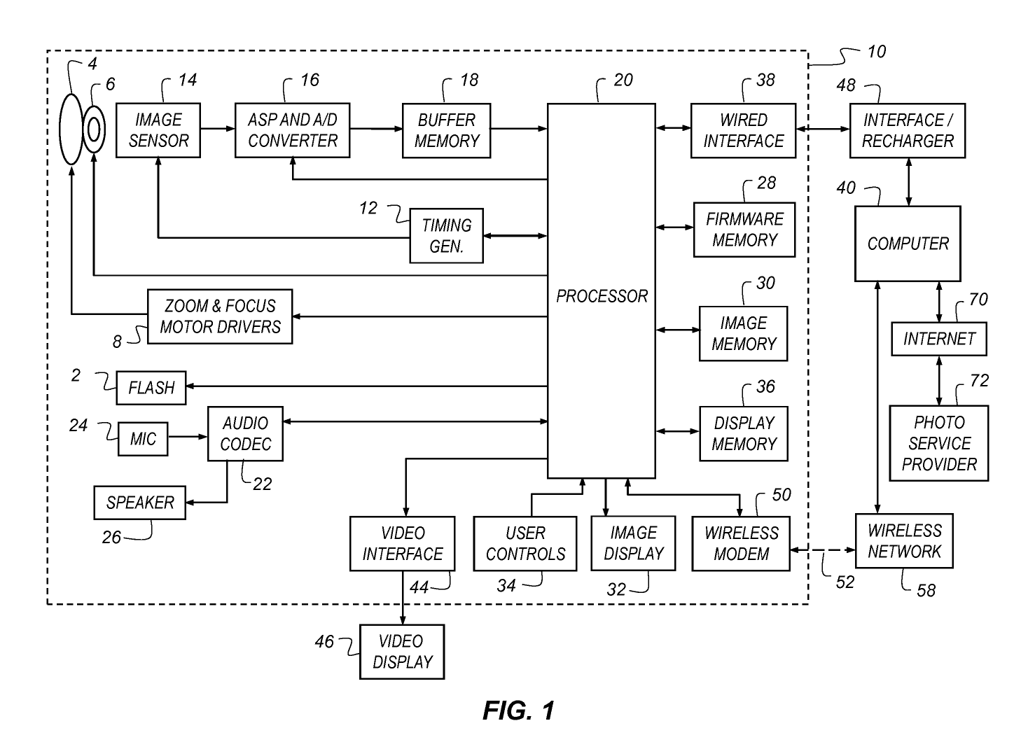

FIG. 1 depicts a block diagram of a digital photography system, including a digital camera 10 in accordance with the present invention. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file”, as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a lens 4 having an adjustable aperture and adjustable shutter 6. In a preferred embodiment, the lens 4 is a zoom lens and is controlled by zoom and focus motor drives 8. The lens 4 focuses light from a scene (not shown) onto an image sensor 14, for example, a single-chip color CCD or CMOS image sensor. The lens 4 is one type optical system for forming an image of the scene on the image sensor 14. In other embodiments, the optical system may use a fixed focal length lens with either variable or fixed focus.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using the wired interface 38 or the wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by a timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor is generally overlaid with a color filter array, which provides an image sensor having an array of pixels that include different colored pixels. The different color pixels can be arranged in many different patterns. As one example, the different color pixels can be arranged using the well-known Bayer color filter array, as described in commonly assigned U.S. Pat. No. 3,971,065, “Color imaging array” to Bayer, the disclosure of which is incorporated herein by reference. As a second example, the different color pixels can be arranged as described in commonly assigned U.S. Patent Application Publication 2007/0024931 to Compton and Hamilton, entitled “Image sensor with improved light sensitivity,” the disclosure of which is incorporated herein by reference. These examples are not limiting, and many other color patterns may be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly fewer columns and rows of data, compared to the resolution of the image sensor.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al., entitled “Electronic camera for initiating capture of still images while previewing motion images,” which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length setting and to focus the scene onto the image sensor 14. The exposure level of the image sensor 14 is controlled by controlling the f/number and exposure time of the adjustable aperture and adjustable shutter 6, the exposure period of the image sensor 14 via the timing generator 12, and the gain (i.e., ISO speed) setting of the ASP and A/D converter 16. The processor 20 also controls a flash 2 which can illuminate the scene.

The lens 4 of the digital camera 10 can be focused in the first mode by using “through-the-lens” autofocus, as described in commonly-assigned U.S. Pat. No. 5,668,597, entitled “Electronic Camera with Rapid Automatic Focus of an Image upon a Progressive Scan Image Sensor” to Parulski et al., which is incorporated herein by reference. This is accomplished by using the zoom and focus motor drivers 8 to adjust the focus position of the lens 4 to a number of positions ranging between a near focus position to an infinity focus position, while the processor 20 determines the closest focus position which provides a peak sharpness value for a central portion of the image captured by the image sensor 14. The focus distance which corresponds to the closest focus position can then be utilized for several purposes, such as automatically setting an appropriate scene mode, and can be stored as metadata in the image file, along with other lens and camera settings.

The processor 20 produces menus and low resolution color images that are temporarily stored in display memory 36 and are displayed on the image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the image display 32 is controlled in response to user input provided by user controls 34. The user controls 34 are used to select various camera modes, such as video capture mode, still capture mode, and review mode, and to initiate capture of still images, recording of motion images. The user controls 34 are also used to set user processing preferences, and to choose between various photography modes based on scene type and taking conditions. In some embodiments, various camera settings may be set automatically in response to analysis of preview image data, audio signals, or external signals such as GPS, weather broadcasts, or other available signals.

In some embodiments, when the digital camera is in a still photography mode the above-described preview mode is initiated when the user partially depresses a shutter button, which is one of the user controls 34, and the still image capture mode is initiated when the user fully depresses the shutter button. The user controls 34 are also used to turn on the camera, control the lens 4, and initiate the picture taking process. User controls 34 typically include some combination of buttons, rocker switches, joysticks, or rotary dials. In some embodiments, some of the user controls 34 are provided by using a touch screen overlay on the image display 32. In other embodiments, the user controls 34 can include a means to receive input from the user or an external device via a tethered, wireless, voice activated, visual or other interface. In other embodiments, additional status displays or images displays can be used.

The camera modes that can be selected using the user controls 34 include a “timer” mode. When the “timer” mode is selected, a short delay (e.g., 10 seconds) occurs after the user fully presses the shutter button, before the processor 20 initiates the capture of a still image.

An audio codec 22 connected to the processor 20 receives an audio signal from a microphone 24 and provides an audio signal to a speaker 26. These components can be used to record and playback an audio track, along with a video sequence or still image. If the digital camera 10 is a multi-function device such as a combination camera and mobile phone, the microphone 24 and the speaker 26 can be used for telephone conversation.

In some embodiments, the speaker 26 can be used as part of the user interface, for example to provide various audible signals which indicate that a user control has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include a wireless modem 50, which interfaces over a radio frequency band 52 with the wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak EasyShare Gallery. Other devices (not shown) can access the images stored by the photo service provider 72.

In alternative embodiments, the wireless modem 50 communicates over a radio frequency (e.g. wireless) link with a mobile phone network (not shown), such as a 3GSM network, which connects with the Internet 70 in order to upload digital image files from the digital camera 10. These digital image files can be provided to the computer 40 or the photo service provider 72.

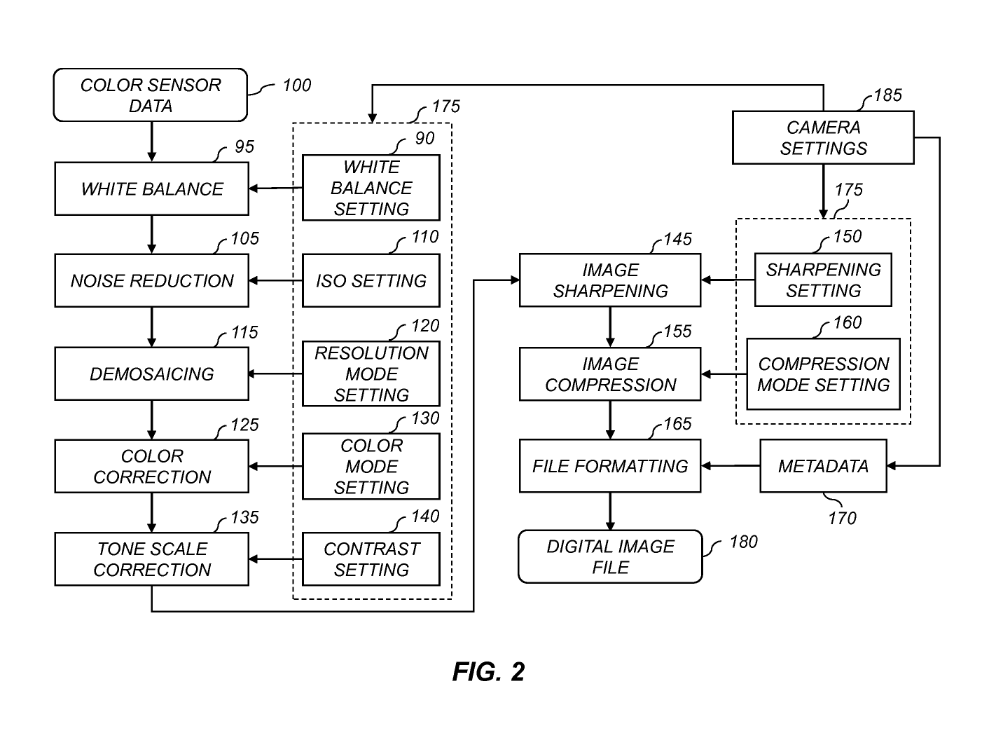

FIG. 2 is a flow diagram depicting image processing operations that can be performed by the processor 20 in the digital camera 10 (FIG. 1) in order to process color sensor data 100 from the image sensor 14 output by the ASP and A/D converter 16. In some embodiments, the processing parameters used by the processor 20 to manipulate the color sensor data 100 for a particular digital image are determined by various photography mode settings 175, which are typically associated with photography modes that can be selected via the user controls 34, which enable the user to adjust various camera settings 185 in response to menus displayed on the image display 32.

The color sensor data 100 which has been digitally converted by the ASP and A/D converter 16 is manipulated by a white balance step 95. In some embodiments, this processing can be performed using the methods described in commonly-assigned U.S. Pat. No. 7,542,077 to Miki, entitled “White balance adjustment device and color identification device”, the disclosure of which is herein incorporated by reference. The white balance can be adjusted in response to a white balance setting 90, which can be manually set by a user, or which can be automatically set by the camera.

The color image data is then manipulated by a noise reduction step 105 in order to reduce noise from the image sensor 14. In some embodiments, this processing can be performed using the methods described in commonly-assigned U.S. Pat. No. 6,934,056 to Gindele et al., entitled “Noise cleaning and interpolating sparsely populated color digital image using a variable noise cleaning kernel,” the disclosure of which is herein incorporated by reference. The level of noise reduction can be adjusted in response to an ISO setting 110, so that more filtering is performed at higher ISO exposure index setting.

The color image data is then manipulated by a demosaicing step 115, in order to provide red, green and blue (RGB) image data values at each pixel location. Algorithms for performing the demosaicing step 115 are commonly known as color filter array (CFA) interpolation algorithms or “deBayering” algorithms. In one embodiment of the present invention, the demosaicing step 115 can use the luminance CFA interpolation method described in commonly-assigned U.S. Pat. No. 5,652,621, entitled “Adaptive color plane interpolation in single sensor color electronic camera,” to Adams et al., the disclosure of which is incorporated herein by reference. The demosaicing step 115 can also use the chrominance CFA interpolation method described in commonly-assigned U.S. Pat. No. 4,642,678, entitled “Signal processing method and apparatus for producing interpolated chrominance values in a sampled color image signal”, to Cok, the disclosure of which is herein incorporated by reference.

In some embodiments, the user can select between different pixel resolution modes, so that the digital camera can produce a smaller size image file. Multiple pixel resolutions can be provided as described in commonly-assigned U.S. Pat. No. 5,493,335, entitled “Single sensor color camera with user selectable image record size,” to Parulski et al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511, entitled “Method and apparatus for improving the color rendition of hardcopy images from electronic cameras” to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

$$\begin{matrix}Setting 1 ( normal color reproduction ) \\ [ \begin{matrix}{R}_{out} \\ {G}_{out} \\ {B}_{out}\end{matrix} ] = [ \begin{matrix}1.50 & - 0.30 & - 0.20 \\ - 0.40 & 1.80 & - 0.40 \\ - 0.20 & - 0.20 & 1.40\end{matrix} ] [ \begin{matrix}{R}_{i n} \\ {G}_{i n} \\ {B}_{i n}\end{matrix} ] & ( 1 ) \\ Setting 2 ( saturated color reproduction ) \\ [ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{i n} \\ {G}_{i n} \\ {B}_{i n}\end{matrix} ] & ( 2 ) \\ Setting 3 ( de \text{-} saturated color reproduction ) \\ [ \begin{matrix}{R}_{out} \\ {G}_{out} \\ {B}_{out}\end{matrix} ] = [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{i n} \\ {G}_{i n} \\ {B}_{i n}\end{matrix} ] & ( 3 ) \\ Setting 4 ( monochrome ) \\ [ \begin{matrix}{R}_{out} \\ {G}_{out} \\ {B}_{out}\end{matrix} ] = [ \begin{matrix}0.30 & 0.60 & 0.10 \\ 0.30 & 0.60 & 0.10 \\ 0.30 & 0.60 & 0.10\end{matrix} ] [ \begin{matrix}{R}_{i n} \\ {G}_{i n} \\ {B}_{i n}\end{matrix} ] & ( 4 )\end{matrix}$$

In other embodiments, a three-dimensional lookup table can be used to perform the color correction step 125.

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables is stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135.

The color image data is also manipulated by an image sharpening step 145. In some embodiments, this can be provided using the methods described in commonly-assigned U.S. Pat. No. 6,192,162 entitled “Edge enhancing colored digital images” to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness”, 1.0 for “normal sharpness”, and 0.5 for “low sharpness” levels, responsive to a sharpening setting 150 selected by the user of the digital camera 10.

The color image data is also manipulated by an image compression step 155. In some embodiments, the image compression step 155 can be provided using the methods described in commonly-assigned U.S. Pat. No. 4,774,574, entitled “Adaptive block transform image coding method and apparatus” to Daly et al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in a digital image file 180 using a file formatting step 165. The image file can include various metadata 170. Metadata 170 is any type of information that relates to the digital image, such as the model of the camera that captured the image, the size of the image, the date and time the image was captured, and various camera settings, such as the lens focal length, the exposure time and f-number of the lens, and whether or not the camera flash fired. In a preferred embodiment, all of this metadata 170 is stored using standardized tags within the well-known Exif-JPEG still image file format. In a preferred embodiment of the present invention, the metadata 170 includes information about various camera settings 185, including the photography mode settings 175.

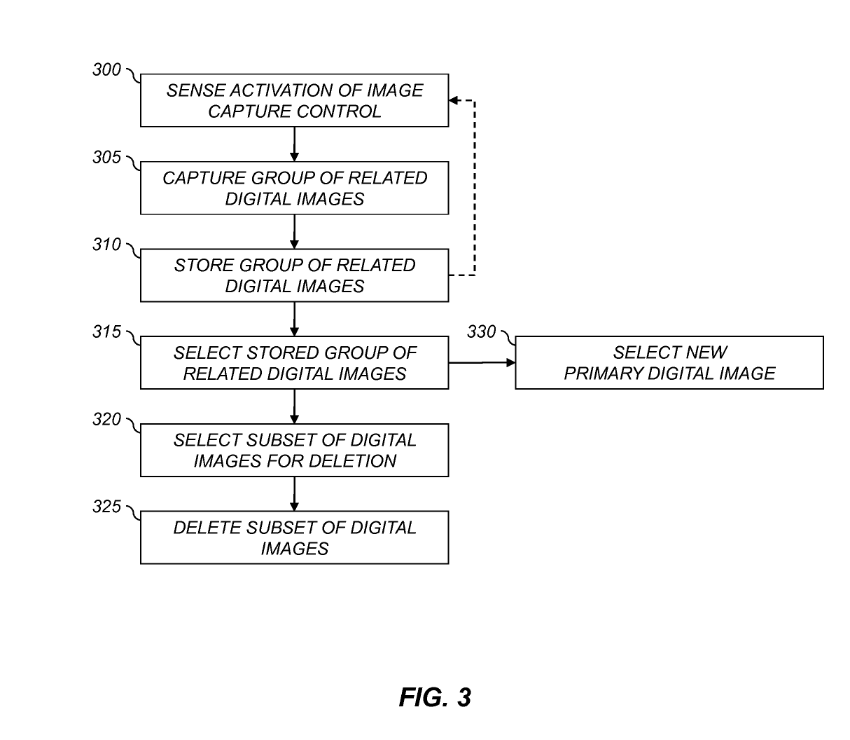

The present invention will now be described with reference to FIG. 3. A sense activation of image capture control step 300 is used to sense an activation of an image capture control on the digital camera 10 (FIG. 1). The image capture control is one of the user controls 34 (FIG. 1). Preferably, the image capture control is a shutter button, or some user interface element that performs an equivalent function. In response to the activation of the user interface control, a capture group of related digital images step 305 is used to capture a group of related digital images. In a preferred embodiment, the group of related digital images includes a time sequence of individual digital still images captured using a predefined time interval, including a primary digital still image captured substantially at the nominal image capture time.

The primary digital still image can be designated in various ways. In some embodiments, the first digital image in the time sequence of individual digital still images is designated to be the primary digital image. In other embodiments the digital still image in the center of the time sequence of individual digital still images can be designated to be the primary digital image. As will be described in more detail later, in a preferred embodiment, the primary digital still image is the digital still image that is captured at the time that a shutter button is fully depressed to an “S2” position. In some embodiments, the user can be enabled to manually change the designation of the primary digital still image.

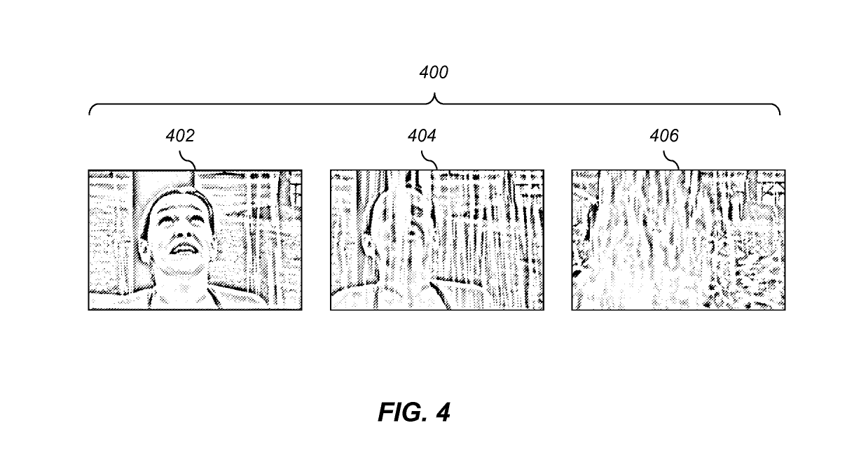

FIG. 4 shows an example of a group of related digital still images 400 including three individual digital still images 402, 404 and 406 that were captured in quick succession showing an action sequence in the scene. In this example, the digital still image 404 is designated to be the primary digital still image.

Returning to a discussion of FIG. 3, a store group of related digital images step 310 is used to store the group of related digital still images 400 (FIG. 4) in a storage memory. In a preferred embodiment, the storage memory is the image memory 30 (FIG. 1). In other embodiments, the storage memory can be the buffer memory 18 (FIG. 1), or some other memory accessible to the processor 20 (FIG. 1). The sense activation of image capture control step 300, the capture group of related digital images step 305 and the store group of related digital images step 310 can optionally be repeated any number of times to capture and store a plurality of groups of related digital still images.

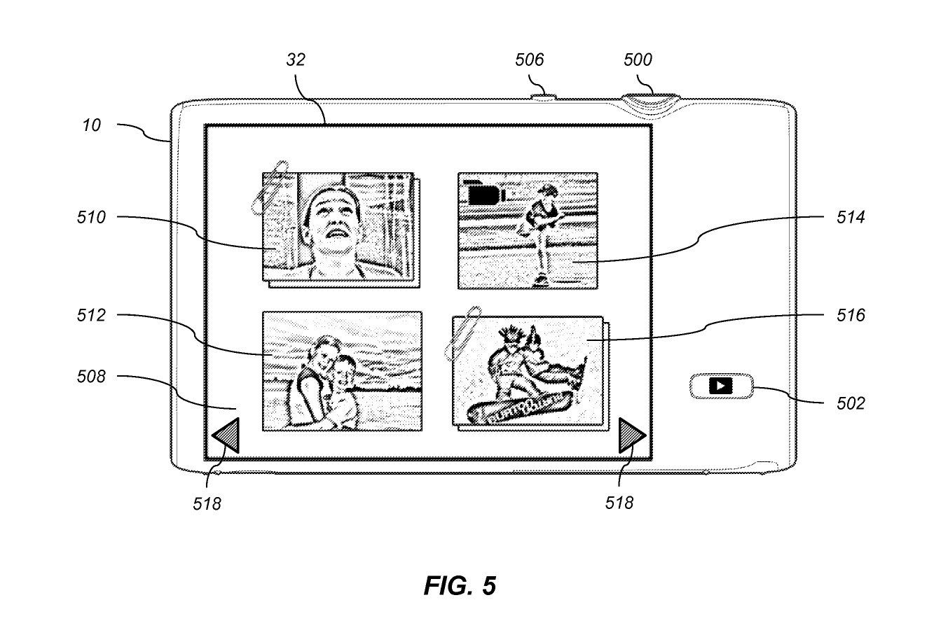

At some later time, a select stored group of related digital images step 315 is used to select a group of related digital still images to be reviewed on the image display 32 (FIG. 1) using an image review process. To enable this, the user controls 34 (FIG. 1) includes one or more user interface elements for enabling the user to select a particular stored group of related digital still images for review on the image display 32. FIG. 5 shows an example of a user interface that can be used to implement the select stored group of related digital images step 315 according to one embodiment. In this configuration the digital camera 10 includes a number of user controls 34 (FIG. 1) including an image capture control 500 (i.e., a shutter button), a review button 502 that can be activated to enter the review mode, and a power button 506 that can be used to power the digital camera on and off.

When the user activates the review button 502, the image display 32 displays a review mode user interface screen 508 including a series of icons representing the digital media assets that have been captured by the digital camera 10 and stored in the image memory 30 (FIG. 1). In this example, the review mode user interface screen 508 shows four icons corresponding to four digital media assets. In a preferred embodiment, the image display 32 is a touch screen display so that the user can interact with displayed user interface elements by touching them with a finger. However, one skilled in the art will recognize that many different types of user interfaces can be used to enable the user to interact with appropriate user interface controls.

Image group icons 510 and 516 correspond to groups of related digital still images that were captured in a burst capture mode. The image group icons 510 and 516 show a thumbnail view of the corresponding primary digital still image, together with a paper clip symbol to indicate that the digital media asset is a group of related digital still images.

Individual image icon 512 corresponds to an individual digital still image that was captured in a conventional image capture mode. The individual image icon 512 shows a thumbnail view of the individual digital still image.

Video clip icon 514 corresponds to a digital video clip that was captured in a video capture mode. The video image icon 514 shows a thumbnail view of a key frame from the digital video clip, together with a movie camera symbol to indicate that the digital media asset is a digital video clip.

Typically, the digital camera 10 will store a collection of digital media assets that includes a larger number of digital media assets than can be shown at any given time on the review mode user interface screen 508.

Accordingly, scroll icons 518 are provided to allow the user to advance through the collection of digital media assets in a forward or reverse direction. Once the user finds the digital media asset that he/she wishes to review, the user can select the digital media asset using the provided user interface elements. In a preferred embodiment, the user can select the desired digital media asset by touching the corresponding icon on the review mode user interface screen 508.

Returning to a discussion of FIG. 3, if the user has selected a group of related digital images for review, the user can perform various actions. One action that a user may desire to perform is to delete a specified subset of the digital still images in the group of related digital still images, retaining only the digital still images that they like. In this case, a select subset of digital images for deletion step 320 is used to select the subset of digital images that the user does not want to keep.

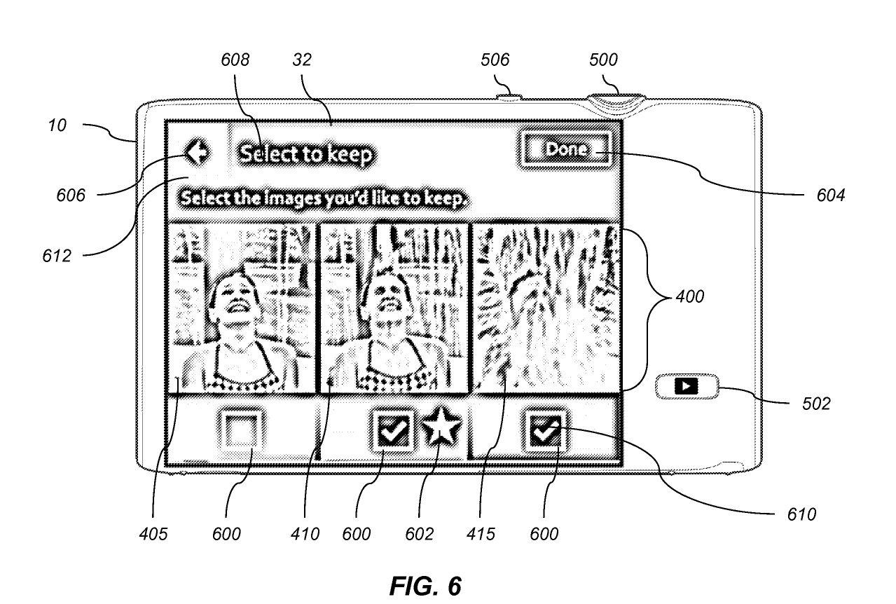

FIG. 6 shows an example of an edit group user interface screen 612 that can be used to perform various operations on a selected group of related digital still images 400, including selecting a subset of digital images for deletion. The edit group user interface screen 612 includes preview images for each of the individual digital still images in the selected group of related digital still images 400. In this example, the preview images are cropped to a “portrait” orientation to fit within the format of the edit group user interface screen 612.

The edit group user interface screen 612 includes a series of user interface elements including instructive text 608, and a series of check boxes 600 associated with each of the individual digital still images. The user can indicate whether or not they want to delete a particular digital still image by adding or removing a check mark 610 from the corresponding check box 600. In this particular embodiment, the presence of a check mark 610 means that the user wants to keep the individual digital still image and an absence of a check mark 610 means that the user wants to delete the individual digital still image. In a preferred embodiment, the user can toggle the check mark 610 on and off by touching the corresponding check box 600 a finger.

In various embodiments, the check boxes 600 can be initialized using different strategies when the edit group user interface screen 612 is initially displayed. In one embodiment, the check boxes 600 are all initialized to indicate that the individual digital images should all be kept. The user then needs to manually indicate any digital images that he/she wants to delete. In an alternate embodiment, it can be assumed that the user will generally only want to retain the primary digital image. In this case, the check boxes 600 can be initialized so that all of the individual digital images except for the primary digital image are designated for deletion. In some implementations, the user can be enabled to specify a preferred default behavior according to user preference settings.

Once the user has finished designating the subset of the digital still images in the group of related digital still images 400 for deletion, the user can activate a done button 604 to initiate the deletion of the designated subset from the selected group of related digital still images 400. This action is represented in FIG. 3 by a delete subset of digital images step 325. A back button 606 is provided to allow the user to exit the edit group user interface screen 612 without deleting any digital still images or saving any other changes.

It will be obvious to one skilled in the art that other user interface arrangements can be used in accordance with the present invention to enable the user to designate a subset of the digital still images in the group of related digital still images 400 for deletion. The exact form of the user interface arrangement will depend on various factors such as the type of user interface controls that are available (e.g., touch screen, buttons, five-way controller, etc.), as well as preferences of the user interface designer.

The edit group user interface screen 612 also includes a primary image indicator 602 (e.g., a star symbol) that indicates which of the digital still images in the group of related digital still images 400 is the primary digital still image. In some embodiments, one or more user interface elements can be provided to enable the user to change which digital still image in the group of related digital still images 400 is designated to be the primary digital still image. This action is shown in FIG. 3 as a select new primary digital image step 330.

Various user interface elements can be used to enable the user to designate a different digital still image to be the primary digital still image. In one embodiment, if the user touches one of the individual digital still images in the group of related digital still images 400 on the edit group user interface screen 612 in FIG. 6, it will bring up an edit image user interface screen which shows a larger view of the selected digital still image and offers additional functionality.

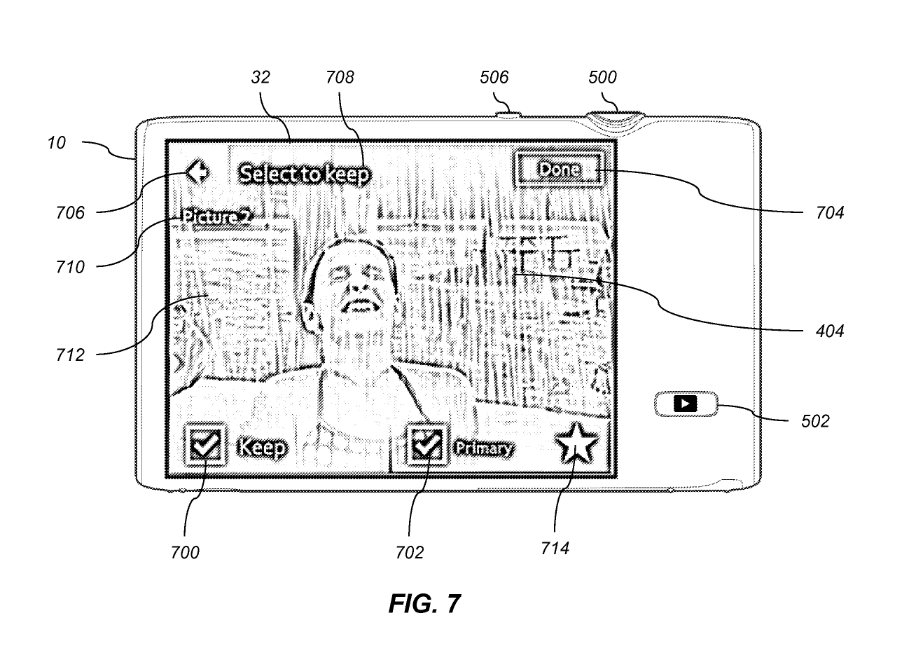

FIG. 7 shows an example of an edit image user interface screen 712 according to one embodiment. The edit image user interface screen 712 shows an enlarged view of the selected digital still image 404, together with image identifier text 710 corresponding to the selected digital still image 404 and instructive text 708, as well as other various user interface elements. A keep image check box 700 can be used to indicate whether the user wants to keep or delete the selected digital still image 404. (This user interface element is redundant with the check boxes 600 in FIG. 6.) Consistent with the edit group user interface screen 612 of FIG. 6, a primary image indicator 714 indicates whether the selected digital still image 404 is currently the primary digital image. A primary digital image check box 702 is provided to enable the user to change the designation of the primary digital image. A done button 704 is provided to allow the user to return to the edit group user interface screen 612, saving any changes that they have made. A back button 706 is provided to allow the user to return to the edit group user interface screen 612 without saving any changes that were made.

In a preferred embodiment, the digital camera 10 has various optional image capture modes, including a “burst image capture” mode which enables the user to capture a sequence of digital still images in a short amount of time. A sequence of digital still images captured in a burst image capture mode can be considered to be a group of related digital still images 400 (FIG. 4).

The burst image capture mode can function with a variety of different behaviors. In one embodiment, when the digital camera 10 is operating in the burst image capture mode, a user initiates a burst capture sequence by activating the image capture control 500 (FIG. 5). The digital camera 10 then continues to capture additional digital still images at regular time intervals until the user releases the image capture control 500. In this way, the number of digital still images in the group of related digital still images can be variable. In some embodiments, the time interval between sequential image captures can be fixed at a value corresponding to a predefined image capture rate (e.g., 4 images/second). In other embodiments, the time interval between sequential image captures can be variable and user interface controls can be provided so that the user can select a desired setting.

In some embodiments, the digital camera 10 can include a burst image capture mode which captures a burst of digital still images with each activation of the image capture control 500 (FIG. 5), even if the user does not hold down the image capture control 500. For example, when the user activates the image capture control 500 at a nominal image capture time, the digital camera can initiate the capture of a sequence of digital still images. The sequence can have a predefined number of digital still images, which can either be fixed or can be user selectable. In this case, the first digital still image in the sequence would generally be designated as the primary digital still image since it corresponds most closely to the nominal image capture time when the user activated the image capture control 500.

In other embodiments, the group of related digital still images can include digital still images that were captured before the nominal image capture time when the user activated the image capture control 500. To enable this feature, the digital camera 10 must be configured to capture and temporarily store digital still images before the user activates the image capture control 500.

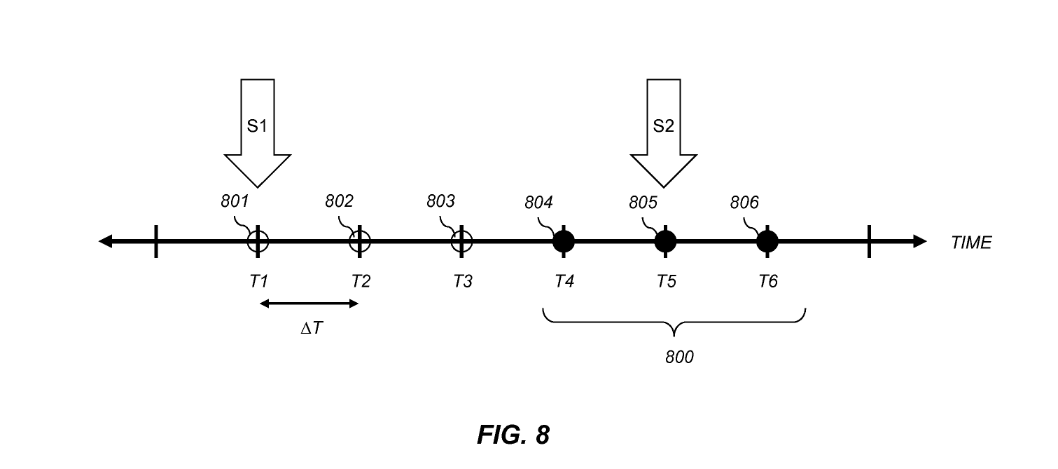

FIG. 8 illustrates a timeline corresponding to one means for capturing a group of related digital still images 800 that includes digital still images captured before the primary digital still image. At a time T1, a user partially activates the image capture control 500 (FIG. 5) by partially depressing it to an “S1” position. This causes the digital camera 10 (FIG. 1) to perform various actions associated with preparing to capture a primary digital still image. For example, the digital camera 10 can focus the lens and determine the appropriate exposure level. In some embodiments, this can also cause a sequence of preview images to be displayed on the image display 32 (FIG. 1). The digital camera then proceeds to capture a sequence of digital still images 801-806 at times T1-T6, separated by a time interval ΔT (e.g., ΔT=0.25 sec would correspond to a burst image capture rate of 4 images/sec). The time interval ΔT can be fixed, or can be user selectable.

The sequence of digital still images 801-806 is preferably stored temporarily in buffer memory 18. For cases where the digital camera 10 is configured to display the sequence of preview images, the digital still images 801-806 can correspond to some or all of the preview images. Generally, it will be desirable for the digital still images 801-806 to be stored at a higher resolution than the preview images since the image display 32 will typically use preview images at a relatively low resolution level.

At time T5, the user fully activates the image capture control 500 (FIG. 5) by fully depressing it to an “S2” position. This designates the digital still image 805 captured at time T5 to be the primary digital still image. In a preferred embodiment, the digital camera 10 continues to capture one or more digital still images (e.g., digital still image 806) after the time when the user fully depressed the image capture control 500 to the S2 position. A subset of the captured digital still images 801-806 can then be stored in the image memory 30 (FIG. 1) to form a group of related digital still images 800. In this example, the group of related digital still images 800 includes the primary digital still image 805 captured at the nominal image capture time T5, together with one digital still image 804 captured before the nominal image capture time and another digital still image 806 captured after the nominal image capture time. The number of digital still images before and after the nominal image capture time that are included in the group of related digital still images 800, as well as the time interval ΔT, can be predefined, or can be user selectable with appropriate user interface controls.

Depending on how long the user holds the image capture control 500 (FIG. 5) at the S1 position before fully depressing it to the S2 position, the buffer memory may become full so that there is no room to temporarily store additional digital still images. In this case, when the buffer memory becomes full the oldest stored digital still images can be deleted from the buffer memory to make room for storing new digital still images.

It is only necessary to store a number of digital still images in the image buffer corresponding to the number of digital still images that will be included in the group of related digital still images 800. For example, in the example of FIG. 8, the group of related digital still images 800 includes one digital still image 804 captured before the nominal image capture time and one digital still image 806 captured after the nominal image capture time. In this case, the digital camera only needs to store a single image in the buffer memory 18 (FIG. 1) during the time that the user is holding the image capture control 500 (FIG. 5) in the S1 position. Therefore, when the second digital still image 802 is captured, it can be saved replacing the first digital still image 801 in the buffer memory 18. Likewise, the third digital still image 803 can replace the second digital still image 802, and the fourth digital still image 804 can replace the third digital still image 803. When the user depresses the image capture control 500 to the SS position at time T5, the digital camera can then add digital still images 805 and 806 to the buffer memory without deleting the fourth digital still image 804.

In alternate embodiments, the digital camera may not have a burst mode feature that can be used to conveniently designate groups of related digital still images. In this case, alternate means can be provided for identifying groups of related digital still images. For example, a user interface can be provide that enables a user to manually select a group of digital still images that should be designated to be a group of related digital still images. In other embodiments, a collection of digital still images can be automatically analyzed to identify groups of related digital still images. For example, a set of digital still images having associated capture times that fall within a predefined time interval of each other (e.g., 5 seconds) can be automatically designated to be a group of related digital still images under the assumption that they were captured in rapid succession. In a variation of this approach, an image similarity metric can be calculated for any groups of related digital still images identified in this way to confirm that they appear to be images of the same scene. Only digital still images having a high degree of image similarity will be included in a particular group of related digital images.

In a preferred embodiment, the group of related digital still images 400 (FIG. 4) is treated as a single digital media asset; both within the user interface of the digital camera 10 (FIG. 1), and also within other digital imaging system components. For example, a digital image display device such as a digital picture frame can be adapted to display groups of related digital still images 400 differently than it displays an individual digital still image or a digital video. One such digital image display device is described in commonly-assigned, co-pending U.S. patent application Ser. No. ______ (docket 96751), entitled: “Display device for displaying related digital images,” to Krolczyk et al., which is incorporated herein by reference. According to this approach, a display time duration is defined. As the digital image display device is displaying a sequence of digital media assets its behavior is adapted according to whether the digital media asset is an individual digital still image or whether it is a group of related digital still images 400. If a displayed digital media asset is an individual digital still image, it is displayed for the specified display time duration, and if a displayed digital media asset is a group of related digital still images 400, the display time duration is subdivided into display time duration fractions such that each of the digital still images in the group of related digital still images 400 is displayed for a corresponding display time duration fraction. To enable this functionality, it is necessary to store the group of related digital still images 400 in a manner that records the linkage between the individual digital still images.

In some embodiments, the group of related digital still images 400 can be stored as a set of independent digital image files. In this case, the individual digital still images can be stored together with metadata indicating that the individual digital still images in a particular group of related digital still images 400 are related. In some embodiments, the metadata can be stored in the header of each digital image file associating the digital still image with a group of related digital still images 400. For example, a unique group identifier can be defined for each group of related digital still images 400, and the group identifier can be stored as metadata in each digital still image in the group of related digital still images 400 (e.g., using the metadata format associated with the well-known EXIF digital image file format). In some embodiments, a group sequence value is also stored as metadata indicating an order of the digital still images in the group.

Alternately, the groups of related digital still images 400 can be stored in different ways. For example, rather than storing the metadata that indicates the relationship between the digital still images in the digital image files, a different data file can be created providing a list of groups of related digital still images 400, together with a list of the individual digital still images to be included in each of the groups of related digital still images 400.

In another embodiment, the relationship between the related digital still images can be defined by grouping them into a “folder” within the file structure of the image memory 30 (FIG. 1). This approach can be used for cases where the storage memory (e.g., a removable memory card) uses a hierarchical file system that supports a file folder structure. A separate image group folder can be created in the file system for storing each group of related digital still images 400. The individual digital still images in the group of related digital still images 400 can then be stored in the corresponding image group folder to indicate that they are associated with each other. In this way, all of the digital still images within an image group folder can be assumed to be members of a group of related digital still images 400.

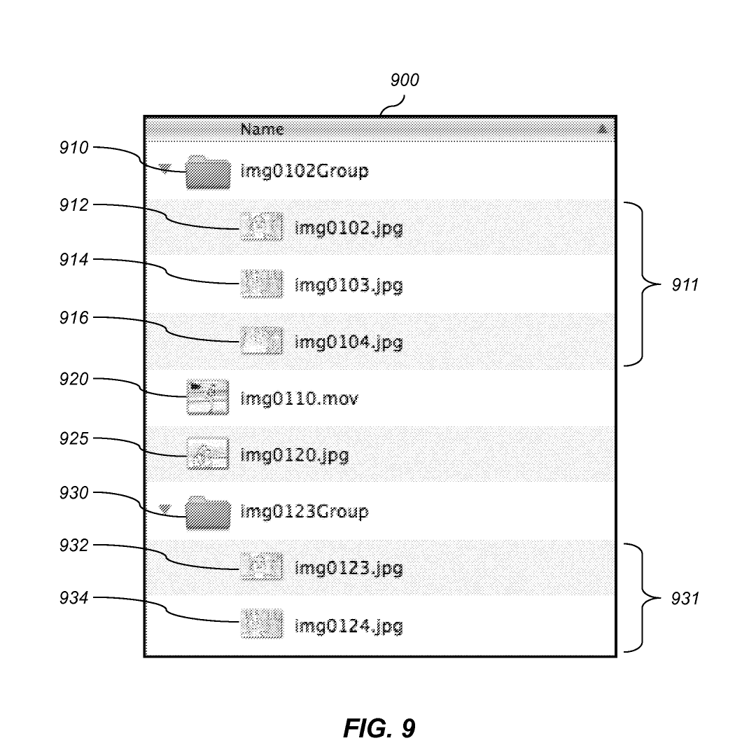

FIG. 9 shows an example of a file folder structure 900 showing a collection of digital media assets stored in an image memory 30 (FIG. 1). The digital media assets include two groups of related digital media assets 911 and 931 stored in image group folders represented by image group folder icons 910 and 930. The first group of related digital media assets 911 includes three individual digital still images represented by digital still image icons 912, 914 and 916. The second group of related digital media assets 931 includes two individual digital still images represented by digital still image icons 932 and 934. The collection of digital media assets also includes a digital video represented by a digital video icon 920 and an individual digital still image represented by a digital still image icon 925. With this arrangement, it can be seen that the file structure itself provides the information indicating which digital still images are related, without the need for defining proprietary metadata.

In other embodiments, the group of related digital images can be stored within a single digital file. For example, the individual digital still images can be combined into a single document and stored using the well-known Portable Document Format (PDF) file format developed by Adobe Systems Inc. Similarly, the group of related digital images could be stored in the well-known Multi-page TIFF (MTIFF) file format. Alternately, each digital still image in the group of related digital images could be stored as a separate image frame in a motion image format such as the well-known Motion JPEG file format.

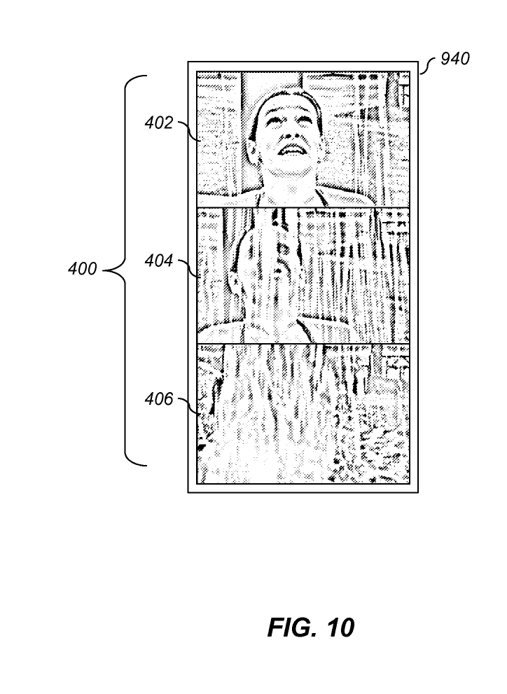

In another embodiment, the digital still images in the group of related digital images are used to form a composite image, which can then be stored using a conventional digital image file format (e.g., EXIF (JPG) or TIFF). FIG. 10 shows an example of a composite image 940 formed by combining the digital still images 402, 404 and 406 in the group of related digital still images 400 from FIG. 4. The composite image 940 can be viewed or printed as desired to provide a representation of the motion that occurred in the scene during the time that the digital still images 402, 404 and 406 were captured.

In an alternate embodiment, the group of related digital still images can be stored in a single file using a proprietary file format. For example, in one configuration the primary digital still image in the group of related digital images can be stored in a digital image file using a conventional digital image file format, and the remaining digital still images in the group of related digital images can be stored as proprietary metadata within the digital still image file. An advantage of this approach is that any general purpose digital imaging application will be able to access the primary digital still image since it is stored in a standard digital image file format. The remaining digital still images can be accessed only by proprietary applications that know how to decode the appropriate metadata.

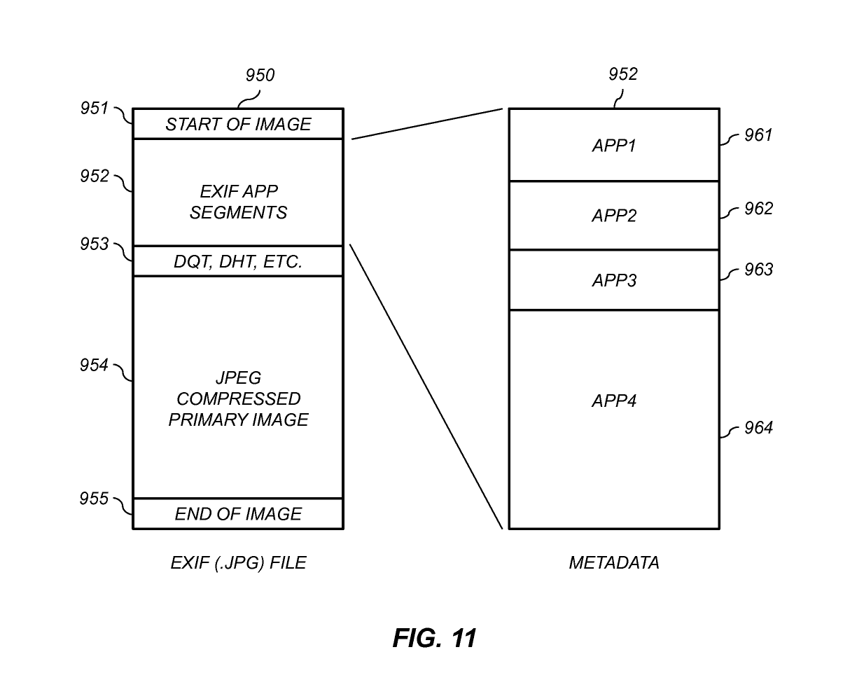

FIG. 11 shows an example of a proprietary file format for storing a group of related digital images based on the well-known EXIF digital image file format. In this configuration, the primary digital still image is compressed as usual and stored in a digital image file 950 as compressed primary image 954. In addition to the compressed primary image 954, the digital image file contains various other data fields including a start of image marker 951, metadata stored in APP segments 952, various tables/headers 953 and an end of file marker 955. The tables/headers 953 includes data used for the image compression such as quantization tables (DQT) and Huffman tables (DHT). The APP segments 952 can be used to store various kinds of metadata. The illustrated example includes an APP1 segment 961, an APP2 segment 962, an APP3 segment 963, and an APP4 segment 964, although different numbers of segments can be used in practice. The APP1 segment 961 is typically used to store a thumbnail image, as well as other information such as the image capture date/time. The APP2 segment 962 is sometimes used to store embedded audio data. The APP3 segment 963 is typically used to store various metadata related to the photographic settings used to capture the digital image. In one embodiment, the remaining digital still images in the group of related digital images can be compressed and stored in one or more APP4 segments. APP4 segments are generally limited to 64K bytes, so it is typically necessary to include multiple APP4 segments to encode the amount of image data associated with the remaining digital still images. In some embodiments, to keep the size of the metadata to a reasonable size, the remaining digital still images can be stored at a lower spatial resolution, or using a lower image compression quality setting relative to the primary digital still image. However, this can limit the usability of the remaining digital still images depending on the intended application.

A computer program product can include one or more non-transitory, tangible, computer readable storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

2 flash
4 lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
26 speaker
28 firmware memory
30 image memory
32 image display
34 user controls
36 display memory
38 wired interface
40 computer
44 video interface
46 video display
48 interface/recharger
50 wireless modem
52 radio frequency band
58 wireless network
70 Internet
72 photo service provider
90 white balance setting
95 white balance step
100 color sensor data
105 noise reduction step
110 ISO setting
115 demosaicing step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 photography mode settings
180 digital image file
185 camera settings
300 sense activation of image capture control step
305 capture group of related digital images step
310 store group of related digital images step
315 select stored group of related digital images step
320 select subset of digital images for deletion step
325 delete subset of digital images step
330 select new primary digital image step
400 group of related digital still images
402 digital still image
404 digital still image
406 digital still image
500 image capture control
502 review button
506 power button
508 review mode user interface screen
510 image group icon
512 individual image icon
514 video clip icon
516 image group icon
518 scroll icons
600 check box
602 primary image indicator
604 done button
606 back button
608 instructive text
610 check mark
612 edit group user interface screen
700 keep image check box
702 primary digital image check box
704 done button
706 back button
708 instructive text
710 image identifier text
712 edit image user interface screen
714 primary image indicator
800 group of related digital still images
801 digital still image
802 digital still image
803 digital still image
804 digital still image
805 digital still image
806 digital still image
900 file folder structure
910 image group folder icon
911 group of related digital still images
912 digital still image icon
914 digital still image icon
916 digital still image icon
920 digital video icon
925 digital still image icon
930 image group folder icon
931 group of related digital still images
932 digital still image icon
934 digital still image icon
940 composite image
950 digital image file
951 start of image marker
952 APP segments
953 tables/headers
954 compressed primary image
955 end of image marker
961 APP1 segment
962 APP2 segment
963 APP3 segment
964 APP4 segment

1. A digital camera system for capturing and reviewing a group of related digital still images, comprising:
an image sensor for capturing a digital image;
an optical system for forming an image of a scene onto the image sensor;
a softcopy display;
a user interface including one or more user interface elements, wherein one of the user interface elements is an image capture control;
a data processing system;
a storage memory for storing captured images; and
a program memory communicatively connected to the data processing system and storing instructions configured to cause the data processing system to implement a method for capturing and reviewing a group of related digital still images, wherein the instructions include:
sensing an activation of the image capture control at a nominal image capture time;
capturing a group of related digital still images of the scene at a sequence of image capture times including a primary digital still image captured substantially at the nominal image capture time;
storing the group of related digital still images in the storage memory, together with information indicating that the digital still images are related;
providing one or more user interface elements for enabling a user to select a stored group of related digital still images for review on the softcopy display;
providing one or more user interface elements for enabling the user to designate a subset of the digital still images in a selected group of related digital still images for deletion; and
providing one or more user interface elements to initiate the deletion of a designated subset of digital still images from the selected group of related digital still images.

2. The digital camera system of claim 1 wherein the program memory further stores instructions for providing one or more user interface elements for enabling the user to change which digital still image in the group of related digital still images is designated to be the primary digital still image.

3. The digital camera system of claim 1 wherein the group of related digital still images includes digital still images captured before the primary digital still image.

4. The digital camera system of claim 3 wherein the digital still images captured before the primary digital still image are captured by:
capturing a sequence of digital still images at specified time intervals and storing the captured sequence of digital still images in a buffer memory, wherein when the buffer memory becomes full the oldest stored digital still images are deleted from the buffer memory to make room for storing new digital still images; and
including one or more of the digital still images in the stored sequence of digital images captured at capture times preceding the nominal image capture time in the group of related digital still images.

5. The digital camera system of claim 4 wherein the process of capturing the sequence of digital still images is initiated by partially activating the image capture control.

6. The digital camera system of claim 1 wherein the group of related digital still images includes digital still images captured after the primary digital still image.

7. The digital camera system of claim 6 wherein the digital still images captured after the primary digital still image are captured by:
capturing a sequence of digital still images at specified time intervals after the nominal image capture time; and
including one or more of the digital still images in the sequence of digital images in the group of related digital still images.

8. The digital camera system of claim 1 wherein the user interface elements for enabling the user to designate a subset of the digital still images are initialized such that by default all of the digital still images in the group of related digital still images are designated for deletion except for the primary digital still image.

9. The digital camera system of claim 1 wherein each of the digital still images in the group of related digital still images are stored in individual digital files, together with metadata indicating that the individual digital files are related.

10. The digital camera system of claim 1 wherein the storage memory uses a file system that supports a file folder structure, and wherein the instructions for storing the group of related digital still images in the storage memory include:
creating a group file folder in the file system for storing the group of related digital still images; and
storing each of the digital still images in the group of related digital still images in an individual digital file in the group file folder.

11. The digital camera system of claim 1 wherein the digital still images in the group of related digital still images are stored together in a single digital file.

12. The digital camera system of claim 11 wherein the single digital file is a PDF file or a MTIFF file or a motion JPEG file.

13. The digital camera system of claim 11 wherein the digital still images in the group of related digital still images are used to form a composite image, and wherein the composite image is stored in the single digital file.

14. The digital camera system of claim 11 wherein the single digital file is a digital image file storing the primary digital still image, and wherein the rest of the digital still images in the group of related digital still images are stored as metadata within the digital image file.

15. The digital camera system of claim 13 wherein the digital image file is stored using a standard digital image file format such that general purpose digital imaging applications will be able to access the primary digital still image.

16. The digital camera system of claim 13 wherein the digital image file is stored using the EXIF digital image file format, and wherein the rest of the digital still images in the group of related digital still images are stored in one or more APP segments in the digital image file.

17. The digital camera system of claim 13 wherein the rest of the digital still images in the group of related digital still images are stored at a lower resolution than the primary digital still image.

18. The digital camera system of claim 13 wherein the rest of the digital still images in the group of related digital still images are stored using a lower image compression quality setting relative to the primary digital still image.

19. The digital camera system of claim 1 wherein the group of related digital still images is captured when the digital camera system is set to operate in a burst capture mode.

20. The digital camera system of claim 1 wherein a set of captured digital still images are designated to belong to the group of related digital still images in response to determining that image capture times associated with the captured digital still images fall within a predefined time interval of each other.

21. A digital camera system for capturing and reviewing a group of related digital still images, comprising:
an image sensor for capturing a digital image;
an optical system for forming an image of a scene onto the image sensor;
a softcopy display;
a user interface including one or more user interface elements, wherein one of the user interface elements is an image capture control;
a data processing system;
a storage memory for storing captured images; and
a program memory communicatively connected to the data processing system and storing instructions configured to cause the data processing system to implement a method for capturing and reviewing a group of related digital still images, wherein the instructions include:
sensing an activation of the image capture control at a nominal image capture time;
capturing a group of related digital still images of the scene at a sequence of image capture times including a primary digital still image captured substantially at the nominal image capture time;
storing the group of related digital still images in the storage memory, together with information indicating that the digital still images are related;
providing one or more user interface elements for enabling a user to select a stored group of related digital still images for review on the softcopy display; and
providing one or more user interface elements for enabling the user to change which digital still image in the group of related digital still images is designated to be the primary digital still image.
